(19) United States
(12) Patent Application Publication
(10) Pub. No.: US 2014/0096450 A1
(43) Pub. Date: Apr. 10, 2014

(54) DOOR ASSEMBLY

(71) Applicant: Masonite Corporation, Tampa, FL (US)

(72) Inventor: Douglas THOMPSON, Tampa, FL (US)

(21) Appl. No.: 13/839,001

(22) Filed: Mar. 15, 2013

Related U.S. Application Data
(60) Provisional application No. 61/711,935, filed on Oct. 10, 2012.

(51) Int. Cl. E06B 3/36; E05D 3/02

(52) U.S. Cl. CPC E06B 3/36; E05D 3/02
USPC 49/398; 16/387; 29/434

(57) ABSTRACT

A door assembly comprises a door frame having a hinge side doorjamb, at least two longitudinally spaced hinges, and a door having a hinge side and pivotally mounted on the door frame such that the door is pivotally attached to the door frame through the hinges. The door has at least one slot in the hinge side thereof. Each hinge comprises inner and outer interfolding plates pivotally connected to each other. The inner plate is formed as a generally L-shaped member including a main portion fastened to the door and a tab portion extending at approximately a 90° angle from the main portion and disposed in the at least one slot. The main portion is integrally formed with the tab portion thereof. The outer plate includes a generally U-shaped main portion fastened to the doorjamb and defines an opening sized to receive the main portion of the inner plate.

### CROSS-REFERENCE TO RELATED APPLICATION

This Application claims the benefit under 35 U.S.C. 119(e) of U.S. Provisional Application Ser. No. 61/711,935 filed Oct. 10, 2012 by Douglas Thompson, which is hereby incorporated herein by reference in its entirety.

### FIELD OF THE INVENTION

The present invention relates to door assemblies in general, and more particularly to a door assembly including a door provided for adjustably receiving a door hinge.

### BACKGROUND OF THE INVENTION

The installation of doors is a task frequently requiring the expertise of a carpenter due to a need to make sure the door is properly connect to the frame by its hinges. If the hinges are not properly installed, the door may not open and close properly, or at all. Many consumers find the installation of a door too complicated for the “do it yourself” consumers. Similarly, retailers typically carry few if any doors, due to the inability of the consumer to satisfactorily install the door.

The disclosed invention simplifies the door installation process, thus allowing consumers to install doors.

### SUMMARY OF THE INVENTION

A hinge comprises inner and outer interfolding plates pivotally connected to each other. The inner plate is formed as a generally L-shaped member including a main portion provided with screw holes and a tab portion extending at approximately a 90° angle from the main portion. The main portion of the inner plate is integrally formed with the tab portion thereof. The outer plate includes a generally U-shaped main portion provided with screw holes and defining an opening sized to receive the main portion of the inner plate.

A door assembly comprises a door frame having a hinge side doorjamb. At least two longitudinally spaced hinges are provided. A door has a hinge side pivotally mounted on the door frame such that the hinge side of the door is pivotally attached to the hinge side doorjamb of the door frame through the door hinges longitudinally spaced from each other along said hinge side doorjamb. The door has at least one slot in the hinge side of the door. Each of the hinges comprises inner and outer interfolding plates pivotally connected to each other. The inner plate is a generally L-shaped member including a main portion fastened to the door and a tab portion extending at approximately a 90° angle from the main portion and disposed in the at least one slot. The main portion of the inner plate is integrally formed with the tab portion. The outer plate includes a generally U-shaped main portion fastened to the hinge side doorjamb and defining an opening sized to receive the main portion of said inner plate.

The method for installation of a door to a door frame includes the steps of providing a door frame having a hinge side doorjamb. At least two hinges are provided, with each of the hinges comprising inner and outer interfolding plates pivotally connected to each other. The inner plate is formed as a generally L-shaped member including a main portion and a tab portion extending at approximately a 90° angle from the main portion. The main portion of the inner plate is integrally formed with the tab portion. The outer plate includes a generally U-shaped main portion defining an opening sized to receive the main portion of the inner plate. A door having at least one slot therein is provided, with at least one slot in the door being longer in length then the inner plate of each of the hinges. The U-shaped main portion of the outer plate of the hinges is fastened to the hinge side doorjamb. The tab portion of the inner plate of the hinges is inserted into the at least one slot in the door. The main portion of the inner plate of the hinges is fastened to the hinge side doorjamb.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is an elevational view of a door assembly according to an exemplary embodiment of the present invention;

FIG. 2 is an exploded perspective view of a door of the door assembly of FIG. 1;

FIG. 3 is a partial exploded perspective view of the door assembly according to a first exemplary embodiment of the present invention;

FIG. 4 is a perspective view of the door of according to alternative embodiment of the present invention;

FIG. 5 is a perspective view of a door hinge according to the first exemplary embodiment of the present invention;

FIG. 6 is a bottom view of the door hinge according to the first exemplary embodiment of the present invention;

FIG. 7 is a sectional view of a hinge stile of the door assembly according to the first exemplary embodiment of the present invention;

FIG. 8 is a sectional view of the hinge stile with the door hinge of the door assembly according to the first exemplary embodiment of the present invention in an open position;

FIG. 9 is a sectional view of the hinge stile with the door hinge of the door assembly according to the first exemplary embodiment of the present invention in an closed position;

FIG. 10 is a sectional view of the door assembly according to the first exemplary embodiment of the present invention;

FIG. 11 is a perspective view of a bore cap adapted to fit into a bore in a door jamb;

FIG. 12 is a perspective view of a door of according to a second exemplary embodiment of the present invention;

FIG. 13 is a sectional view of a hinge stile of the door assembly according to the second exemplary embodiment of the present invention;

FIG. 14 is a perspective view of a door hinge according to the second exemplary embodiment of the present invention; and

FIG. 15 is a top view of the door hinge according to the second exemplary embodiment of the present invention.

### DETAILED DESCRIPTION OF EXEMPLARY EMBODIMENTS AND EXEMPLARY METHODS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “downwardly,” “upwardly,” etc.) should be construed to refer to the orientation as then described or as shown in the drawing figure under discussion and to the orientation relative to a vehicle body. These relative terms are for convenience of description and normally are not intended to require a particular orientation. Teens concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the word “a” as used in the claims means “at least one”.

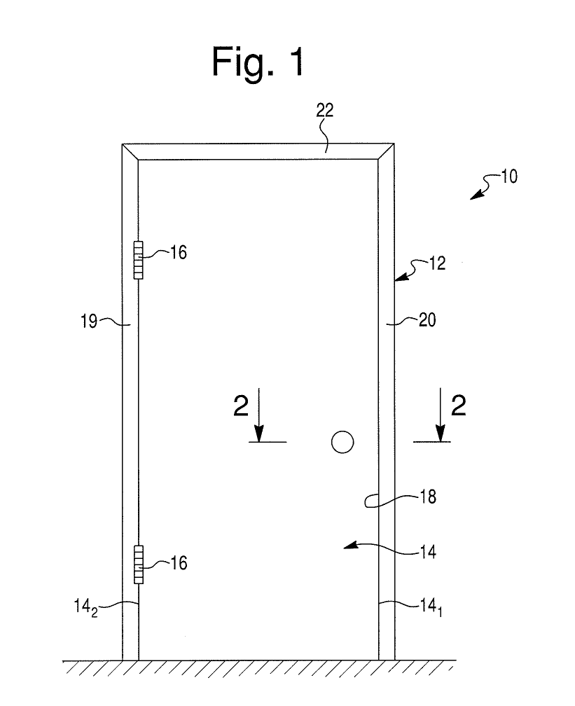

FIG. 1 of the drawings illustrates a folding door assembly according to a first exemplary embodiment of the present invention, generally denoted by reference numeral 10. It should be understood that the present invention is applicable to a folding door, window, screen or similar closure.

The door assembly 10 includes a door frame 12 and a hollow core door 14 pivotally mounted on the door frame 12 through door hinges 16 according to the first exemplary embodiment of the present invention. The door frame 12 defines a door opening 18 selectively closeable by the door 14. The door frame 12 conventionally includes a pair of upright or side doorjambs, namely a hinge side doorjamb 19 and a latch (or bore) side doorjamb 20, and a horizontal or head doorjamb 22. According to the exemplary embodiment of the present invention, the side doorjambs 19 and 20 and the head doorjamb 22 have identical cross sectional shapes. The door 14 has a bore side 14₁ and a hinge side 14₂.

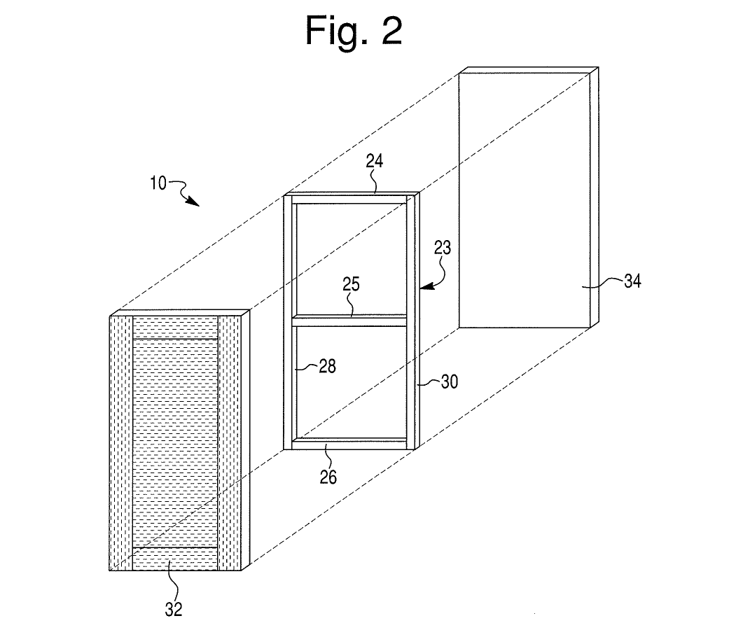

As best shown in FIG. 2, the hollow core door 14 comprises a top rail 24, an optional parallel center rail 25 and a parallel bottom rail 26. Likewise, it has a left stile (or bore stile) 28 and a right stile (or hinge stile) 30 which are attached at their ends to the ends of the rails 24, 25 and 26. The rails 24, 25 and 26, and stiles 28 and 30 form a rectangular frame 23.

The hollow core door 14 further comprises an outer door skin 32 and an inner door skin 34 (also referred to and generally known as “facings”). The outer and inner door skins 32, 34 are substantially parallel to and spaced apart from one another. The door skins are mounted on the rectangular frame 23, frequently formed of wood or plastic, that separates and supports the skins in spaced relationship to one another. A hollow space between the skins and bounded by the door frame typically is filled with an insulating core material, for example, cardboard, paper, fiberboard, or foam such as polyurethane. The skins 32, 34 may be made of wood composites, steel or polymer composites, such as fiberglass reinforced sheet molding compound.

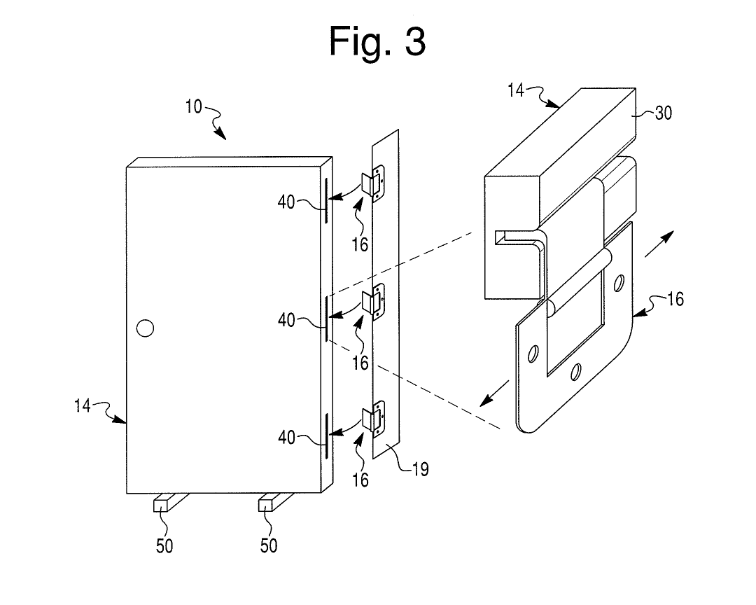

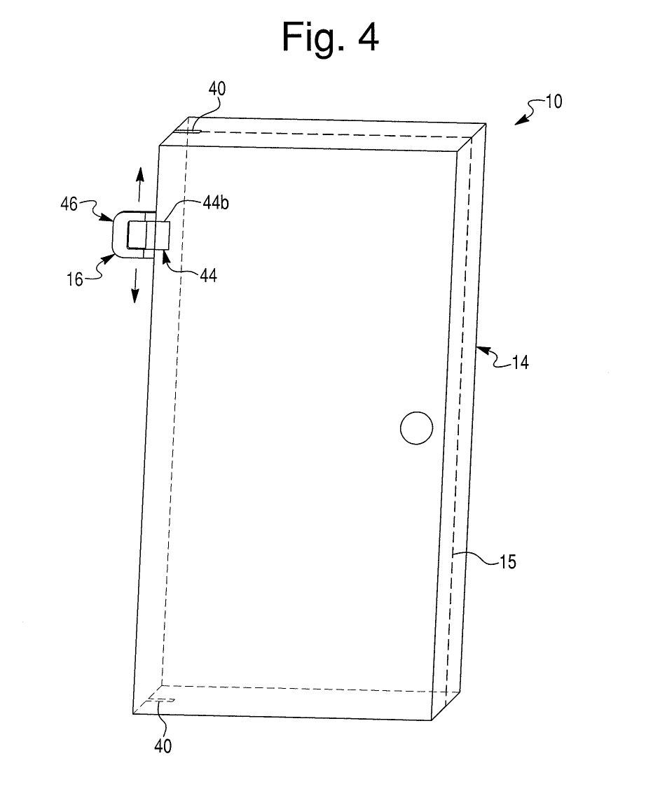

Alternatively, as illustrated in FIGS. 3 and 4, the door 14 may be a solid core door made by laminating two solid halves. Similar to the first embodiment, the solid core door 14 is also pivotally mounted on the door frame 12 through the door hinges 16 according to the first exemplary embodiment of the present invention. It will be appreciated that the door 14 can be not only a solid core door, but also a semi-solid core door, fire door, etc.

The door assembly 10 utilizes specifically designed door hinges 16 and locator slots 40 that are formed in the hinge stile 30 of the door 14. The door assembly 10 also features an easier installation method and a trim package that makes installing the door easier by eliminating the need to have precisely located hinge pockets machined into the door.

The door hinge 16 provides connection between the door frame 12 and the door 14. According to the first exemplary embodiment of the present invention, shown in FIGS. 3-6 and 8-10, the door hinge 16 comprises a hinge pin 41 and a pair of hinge plates (or leaves), namely an inner plate 44 and an outer plate 46, which rotate about the hinge pin 41. The inner plate 44 is fixed to the hinge stile 30 of the door 14, while the outer plate 46 is fixed to the hinge side doorjamb 19 of the door frame 12.

The hinge 16 is a flush or non-mortise hinge with two interfolding or interfitting plates 44, 46 which are screwed or otherwise affixed to the edges of the door 14 and the door frame 12, respectively. The plates 44, 46 are typically each half swaged, and are integrally formed with a respective portion of a knuckle 42 of the hinge 16. The knuckle 42 defines a tubular cavity in which the hinge pin 41 is located.

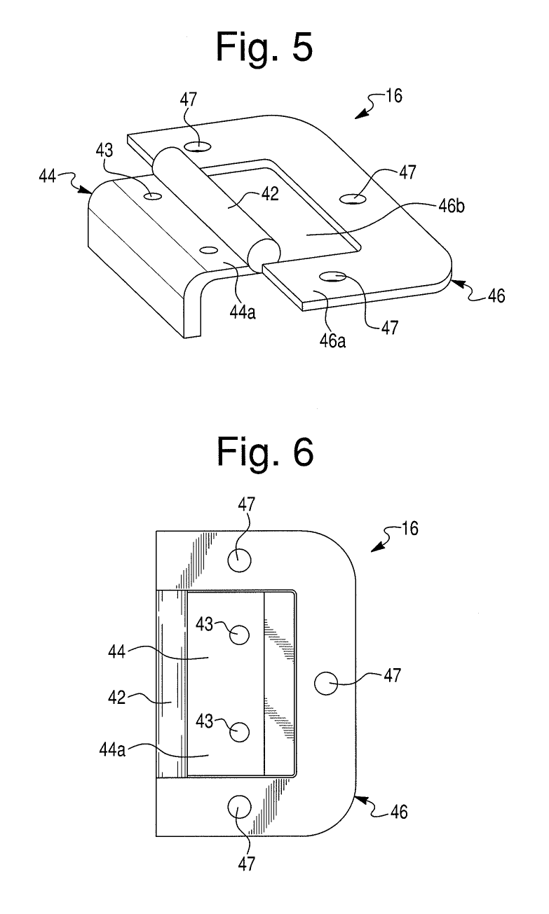

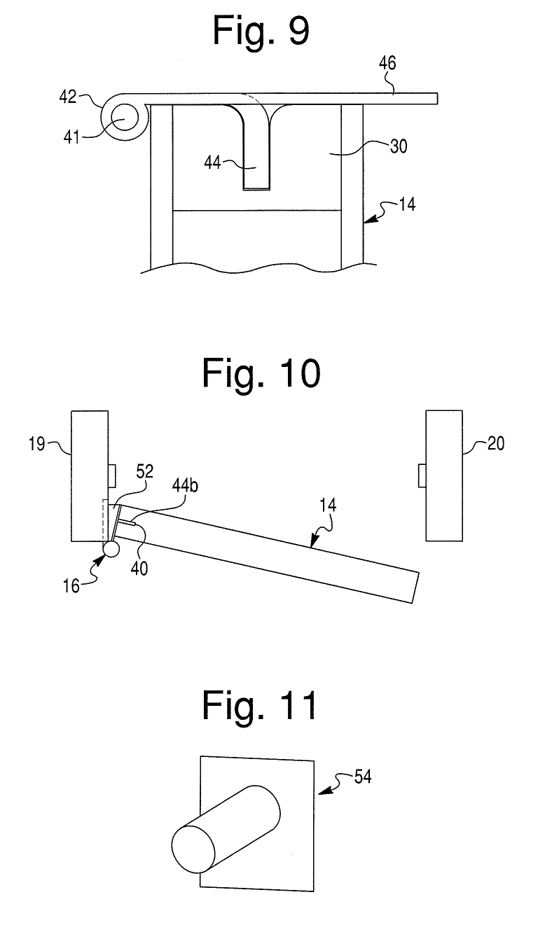

As best shown in FIGS. 5-6, the inner plate 44 is formed as a generally L-shaped member including a main portion 44a provided with screw holes 43, and a tab portion 44b extending at approximately a 90° angle from the main portion 44a. According to the exemplary embodiment of the present invention, the tab portion 44b is barbed or textured to allow it to slide into the slot 41 created on the hinge stile 30 of the door 14 without being easily pulled out. The main portion 44a and the tab portion 44b of the inner plate 44 are formed integrally as a single-piece part. The outer plate 46 includes a generally U-shaped main portion 46a provided with screw holes 47 and defining an opening sized to receive the main portion 44a of the inner plate 44. Accordingly, as best shown in FIGS. 6 and 9, the door hinge 16 according to the exemplary embodiment of the present invention, takes approximately half the thickness of typical hinge when folded onto itself The hinge 16 would fit within a mortised pocket of the hinge side doorjamb 19, with the exception of the tab portion 44b of the inner plate 44.

In practice, at least two hinges 16, and normally three hinges 16, are employed to support the weight of the door 14. The inner and outer plates 44, 46 of the hinge 16 are secured to the door 14 and the hinge side doorjamb 19 in the conventional fashion using, for example, screw fasteners.

The slot 40 in the door 14 is located down a centerline 15 of the hinge stile 30. As illustrated in FIG. 3, the multiple slots 40 are located in areas where hinges 16 on the door frame 12 are frequently located. Alternatively, as best illustrated in FIG. 4, a single slot 40 running the entire length of the hinge stile 30 is provided. The slot 40 is designed to encompass a geometry that allows a radius created from the 90° hinge bend of the inner plate 44 of the hinge 16 to be removed from the stile so the hinge 16 may fit flush against the stile. The slot 40 allows creating the necessary alignment to the placement of the hinge 16 on the width of the door 14.

According to the exemplary embodiment of the present invention, the slot 40 in the door 14 is longer in length than a typical hinge pocket. Moreover, the entire hinge 16 is contained within the frame pocket (minus the tab portion 44b) and allows the door 14 to adapt on the vertical plane (by allowing the tab portion 44b to fit into the slot 40) to the door frame 12 that is installed in the home which has various spacings and configurations. Also, the slot 40 in the door 14 is longer in length then the inner plate 44 of the door hinge 16. Since the hinge 16 is inserted into the slot 40 located along the centerline 15 of the door 14, it can be placed in from either direction (front or back).

The method for installation of the door 14 is also simplified and expedited. First, the outer plate 46 of the hinge 16 is installed into the frame pocket conventionally formed in the hinge side doorjamb 19 of the door frame 12 by applying screw fasteners through the screw holes 47 in the outer plate 46 of the hinge 16 into the hinge side doorjamb 19 of the door frame 12. Next, the door 14 is raised to the correct height by the use of shims (or wedges) 50 on the floor (as illustrated in FIG. 3). Then, the hinge 16 is opened and a force is applied to the door 14 from the bore side 14₁ of the door 14, which will push the tab portion 44b of the inner plate 44 of the hinge 16 into the slot 40. To reduce the chances of the tab portion 44b of the hinge 16 being inserted into the wrong area of the slot 40, a wedge 52 may be placed between the inner and outer plates 44, 46 of the hinge 16 (as illustrated in FIG. 10) that would allow it a proper angle to fit within the door opening 18 of the door 14 (while placed on the shims 50) while having the bore stile 28 of the door 14 outside the plane of the door opening 18 which would allow the force to be applied to the door 14. The wedge 52, made preferably of magnetic material, allows this operation to go smoother. Upon insertion of the tab portion 44b of the hinge 16 into the slot 40, the door 14 can then be opened, and screws applied through the screw holes 43 of the inner plate 44 of the hinge 16 into the hinge stile 30 to lock the door 14 into place and provide the necessary vertical support.

Additionally, the tab portion 44b of the inner plate 44 of the hinge 16 may be provided with a hole that allows a locking screw to pass through the tab portion 44b and engage the other half of the hinge stile 30, which would eliminate screw pull out. A head of that screw would then be slightly angled and would contact the wood in the hinge side doorjamb 19 (instead of metal) which would collapse and allow this angled screw to be a non-issue.

Sometimes the location of bore holes into a latch may need to be relocated. A simple plastic injected part, such as a bore cap 54 shown in FIG. 11, which could fit into the old (existing) bore location and fill the void of a bore hole and a strike plate, would allow quick cover up of the old location. The new location could be quickly drilled if needed. A simple install template could be used in conjunction with a hammer to outline the new strike location and the remainder to be removed with a knife/chisel/screwdriver.

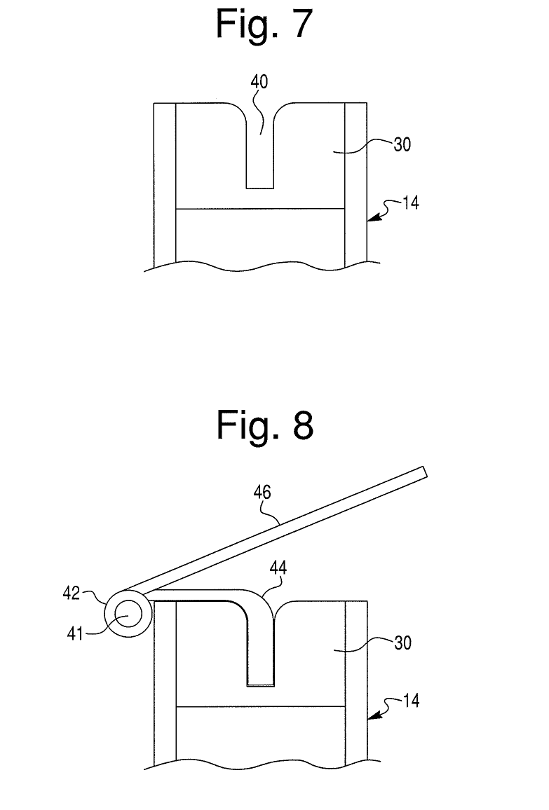

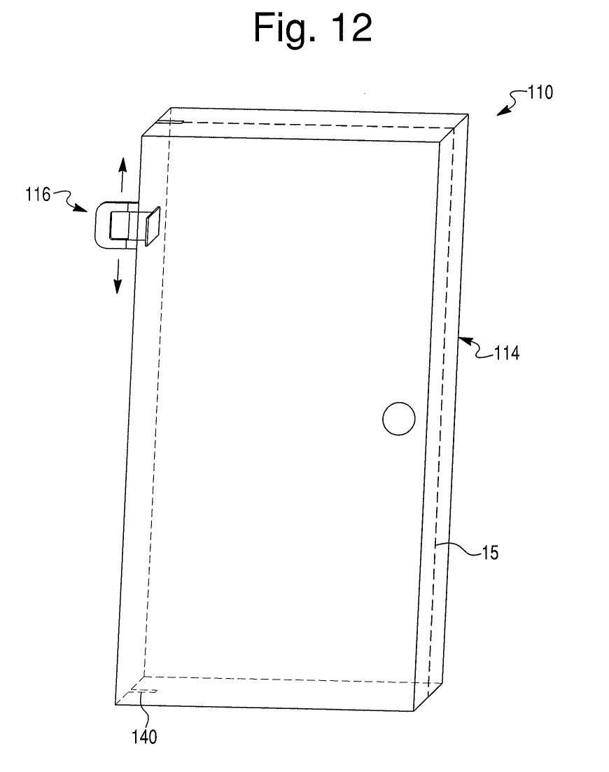

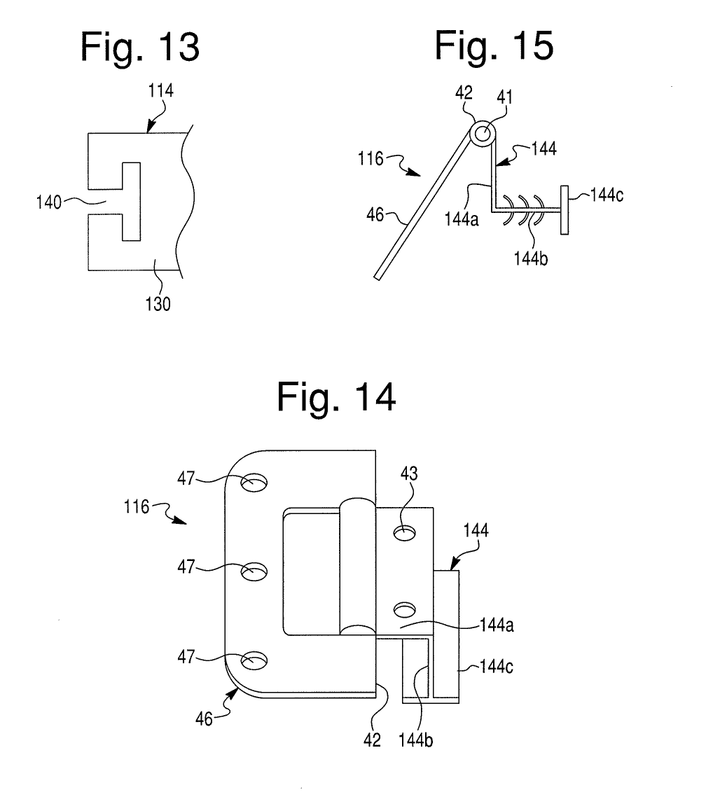

FIGS. 12-15 of the drawings illustrate a folding door assembly according to a second exemplary embodiment of the present invention, generally denoted by reference numeral 110. The door assembly 110 of FIGS. 12-15 according to the second exemplary embodiment of the present invention corresponds substantially to the door assembly 10 of FIGS. 1-10, and only the portions of the door assembly 110, which differ, will therefore be explained in detail below. Components, which are unchanged from, or function in the same way as in the first exemplary embodiment depicted in FIGS. 1-10 are labeled with the same reference characters. Specifically, in accordance with the second exemplary embodiment of the present invention the door assembly 110 includes a door 114 provided with a single slot 140 located down a centerline 15 of the door 114 and running the entire length of a hinge stile 130 of the door 114 as shown in FIGS. 12 and 13. As further illustrated in FIGS. 12 and 13, the single slot 140 has a T-shaped cross-section.

Similarly to the door hinge 16 according to the first exemplary embodiment of the present invention, a door hinge 116 according to the second exemplary embodiment shown in FIGS. 14 and 15, comprises a hinge pin 41 and a pair of hinge plates (or leaves), namely an inner plate 144 and an outer plate 46, which rotate about the hinge pin 41. The inner plate 44 is fixed to the hinge stile 130 of the door 114, while the outer plate 46 is fixed to the hinge side doorjamb 19 of the door frame 12.

The hinge 116 is a flush or non-mortise hinge with two interfolding or interfitting plates 144, 46 which are screwed or otherwise affixed to the edges of the door 114 and the door frame 12, respectively. The plates 144, 46 are typically each half swaged, and are integrally formed with a respective portion of a knuckle 42 of the hinge 116. The knuckle 42 defines a tubular cavity in which the hinge pin 41 is located.

As best shown in FIGS. 14-15, the inner plate 144 is formed as a generally L-shaped member including a main portion 144a provided with screw holes 43, a tab portion 144b extending at approximately a 90° angle from the main portion 144a, and a retaining portion 144c extending at approximately a 90° angle from the tab portion 144b formed integrally, preferably as a single-piece part. The tab portion 144b and the retaining portion 144c of the inner plate 144 together form a T-shaped configuration complementary to the slot 140 so as to allow the hinge 160 to slide up and down along the slot 140.

The method for installation of the door 114 according to the second exemplary embodiment of the present invention is substantially identical to the method for installation of the door 14 according to the first exemplary embodiment.

The door assembly according to the exemplary embodiments of the present invention has the following advantages over the conventional practice in the art:
Precise alignment between the hinge pockets created in the door jamb and the door stile is no longer needed;
Precise location of the door hinge being placed on the width of the door stile is no longer an issue;
Fewer tools and a lower skill level are required for the installation of a replacement door; and
Installation time is reduced substantially for a common user.

The foregoing description of the exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof It is also intended that the scope of the present invention be defined by the claims appended thereto.

What is claimed is:

1. A hinge comprising:
inner and outer interfolding plates pivotally connected to each other;
said inner plate formed as a generally L-shaped member including a main portion provided with screw holes and a tab portion extending at approximately a 90° angle from said main portion;
said main portion of said inner plate being integrally formed with said tab portion thereof;
said outer plate including a generally U-shaped main portion provided with screw holes and defining an opening sized to receive said main portion of said inner plate.

2. The hinge as defined in claim 1, wherein said main portion of said inner plate is integrally formed with said tab portion thereof as a single-piece part.

3. The hinge as defined in claim 1, wherein said tab portion of said inner plate is barbed or textured.

4. The hinge as defined in claim 1, further comprising a hinge pin pivotally connecting said inner and outer interfolding plates to each other.

5. The hinge as defined in claim 1, wherein said inner plate further includes a retaining portion extending at approximately a 90° angle from said tab portion thereof and formed integrally therewith so that said tab portion and said retaining portion of said inner plate together form a T-shaped configuration.

6. A door assembly, comprising:
a door frame having a hinge side doorjamb;
at least two longitudinally spaced hinges; and
a door having a hinge side and pivotally mounted on said door frame such that said hinge side of said door being pivotally attached to said hinge side doorjamb of said door frame through said door hinges longitudinally spaced from each other along said hinge side doorjamb, said door having at least one slot in said hinge side of said door;
each of said hinges comprising inner and outer interfolding plates pivotally connected to each other;
said inner plate formed as a generally L-shaped member including a main portion fastened to said door and a tab portion extending at approximately a 90° angle from said main portion and disposed in said at least one slot;
said main portion of said inner plate being integrally formed with said tab portion thereof;
said outer plate including a generally U-shaped main portion fastened to said hinge side doorjamb and defining an opening sized to receive said main portion of said inner plate.

7. The door assembly as defined in claim 6, wherein said at least one slot in said door is longer in length then said inner plate of each of said hinges.

8. The hinge as defined in claim 6, wherein said main portion of said inner plate of each of said hinges is integrally formed with said tab portion thereof as a single-piece part.

9. The hinge as defined in claim 6, wherein said tab portion of said inner plate of at least one of said hinges is barbed or textured.

10. The hinge as defined in claim 6, wherein each of said hinges further comprises a hinge pin pivotally connecting said inner and outer interfolding plates to each other.

11. The door assembly as defined in claim 6, wherein said door has at least two slots in said hinge side of said door.

12. The door assembly as defined in claim 11, wherein said at least two slots in said door is longer in length then said inner plate of each of said hinges.

13. The door assembly as defined in claim 6, wherein said door has a single slot in said hinge side of said door, said single slot is located down a centerline of said door and extends the entire length of said hinge side of said door.

14. The door assembly as defined in claim 13, wherein said single slot has a T-shaped cross-section.

15. The door assembly as defined in claim 14, wherein said inner plate further includes a retaining portion extending at approximately a 90° angle from said tab portion thereof and formed integrally therewith so that said tab portion and said retaining portion of said inner plate together form a T-shaped configuration.

16. The door assembly as defined in claim 15, wherein said inner plate further includes a retaining portion extending at approximately a 90° angle from said tab portion thereof and formed integrally therewith so that said tab portion and said retaining portion of said inner plate together form a T-shaped configuration complementary to said single slot so as to allow said hinge to slide up and down along said single slot.

17. The method for installation of a door to a door frame, said method comprising the steps of:
(a) providing a door frame having a hinge side doorjamb;
(b) providing at least two hinges, each of said hinges comprising inner and outer interfolding plates pivotally connected to each other, said inner plate formed as a generally L-shaped member including a main portion and a tab portion extending at approximately a 90° angle from said main portion, said main portion of said inner plate being integrally formed with said tab portion thereof, said outer plate including a generally U-shaped main portion defining an opening sized to receive said main portion of said inner plate;
(c) providing a door having at least one slot therein, said at least one slot in said door being longer in length then said inner plate of each of said hinges;
(d) fastening said U-shaped main portion of said outer plate of said hinges to said hinge side doorjamb;
(e) inserting said tab portion of said inner plate of said hinges to said at least one slot in said door; and
(f) fastening said main portion of said inner plate of said hinges to said hinge side doorjamb.
